(19) United States
(12) Patent Application Publication
(10) Pub. No.: US 2018/0011564 A1
(43) Pub. Date: Jan. 11, 2018

(54) Display Surface Structure for Enhanced Optical, Thermal, and Touch Performance

(71) Applicant: DELL PRODUCTS, LP, Round Rock, TX (US)

(72) Inventors: Deeder M. Aurongzeb, Austin, TX (US); Stefan Peana, Austin, TX (US)

(21) Appl. No.: 15/206,929

(22) Filed: Jul. 11, 2016

(51) Int. Cl. G06F 3/042; B32B 17/06

(52) U.S. Cl. CPC G06F 3/042; B32B 17/06; G02B 1/118; G02B 1/18; B32B 2255/20; B32B 2307/754; B32B 2457/208; B32B 2307/408

(57) ABSTRACT

A surface structure for a touch panel display includes a glass layer having a first surface and a second surface. The first surface is on an interior side of the glass layer and the second surface is on an exterior side of the glass layer. The surface structure further includes a first protective layer formed to the first surface, and a second protective layer formed to the second surface. The second protective layer includes an array of bumps on an exterior side of the glass layer. The array of bumps provides a gradation of a refractive index of a material of the second protective layer.

### FIELD OF THE DISCLOSURE

This disclosure generally relates to information handling systems, and more particularly relates to a display surface structure for enhanced optical, thermal, and touch performance in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. An information handling system can include a touch panel display with a protective surface selected to provide a rugged exterior. A coating can be applied to the surface to provide additional toughness, anti-glare and reflection functionality, anti-finger print functionality, or other material functionality that is not provided by the surface material.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a cross-sectional view of a touch panel display according to an embodiment of the present disclosure;

FIG. 2 illustrates a moth-eye surface according to an embodiment of the present disclosure;

FIG. 3 illustrates a process for forming a display surface structure according to an embodiment of the present disclosure;

FIGS. 4-6 are cross-sectional views of various embodiments of protective layers of a display surface structure according to embodiments of the present disclosure;

FIG. 7 is a flowchart illustrating a method of providing a sapphire protective layer for a display surface structure according to an embodiment of the present disclosure; and

FIG. 8 is a block diagram of a generalized information handling system according to an embodiment of the present disclosure.

The following description in combination with the Figures is provided to assist in understanding the teachings disclosed herein. The use of the same reference symbols in different drawings indicates similar or identical items.

### SUMMARY

A surface structure for a touch panel display may include a glass layer having a first surface and a second surface. The first surface may be on an interior side of the glass layer and the second surface may be on an exterior side of the glass layer. The surface structure may further include a first protective layer formed to the first surface, and a second protective layer formed to the second surface. The second protective layer may include an array of bumps on an exterior side of the glass layer. The array of bumps may provide a gradation of a refractive index of a material of the second protective layer.

### DETAILED DESCRIPTION OF DRAWINGS

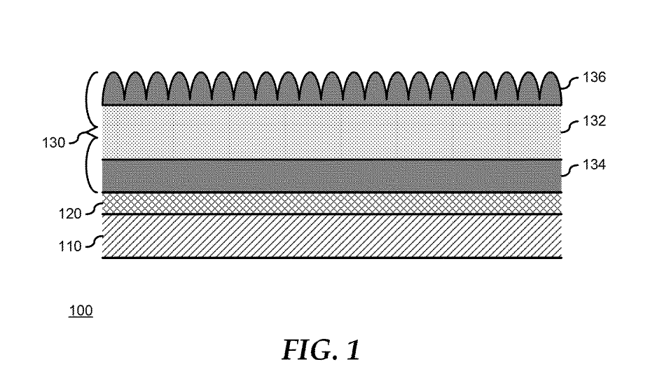

FIG. 1 illustrates an embodiment of a touch panel display 100 including a touch panel display device 110, an adhesive layer 120, and a display surface structure 130. Touch panel display 100 represents a combined video display and input element for a mobile device, such as a smart phone, a tablet device, a laptop computer, a public kiosk device, or another information handling system configured to provide display information and receive touch based input information. As such, touch panel display device 110 represents a device that integrates a display device with a touch panel input device. The display device can include a Liquid Crystal Display (LCD) device, a Light Emitting Diode (LED) display device, or another display device, as needed or desired. The touch panel input device can include a resistive touch panel input device, a capacitive touch panel input device, or another touch panel input device, as needed or desired. The configuration, construction, and assembly of touch panel display device 110 known in the art, and as such, is beyond the scope of the present disclosure, except as otherwise noted herein.

Touch panel display device 110 is bonded to a first surface of adhesive layer 120, and display surface structure 130 is bonded to a second surface of the adhesive layer to create touch panel display 100 as an integrated unit. As such, adhesive layer 120 represents an adhesive bonding material, such as a liquid or semi-liquid adhesive or epoxy, a double-stick adhesive tape, or another bonding material, as needed or desired. The configuration, construction, and assembly of touch panel display device 110 to display surface structure 130 via adhesive layer 120 is known in the art, and as such, is beyond the scope of the present disclosure, except as otherwise noted herein.

Display surface structure 130 represents a fabricated protective surface for touch panel display 100, and includes a glass layer 132 and protective layers 134 and 136. Display surface structure 130 provides a surface for touch panel display 100 that durable and tough, that provides anti-glare, anti-reflection, and anti-finger print functionality, that provides improved thermal conductivity, and that is more resilient than a typical coating. In a particular embodiment, glass layer 132 represents a layer of toughened glass, such as a borosilicate glass or aluminosilicate glass that is annealed or chemically toughened to provide a tough and damage resistant substrate for display surface structure 130. In another embodiment, glass layer 132 represents a layer of organic conductive polymer material.

TABLE 1
Mechanical Properties of Protective Layers

| | | Young's | Thermal | Poisson's | Tensile | Refractive |
|---|---|---|---|---|---|---|
| | CTE (α) | Modulus | Conductivity | Ratio | Strength | Index |
| Material | (10⁻⁶/K) | E (GPa) | k (W/m ° C.) | v | σ_{f} (MPa) | n |
| MgF₂ | 10.40 | 114 | 5.0 | 0.28 | 120 | 1.38 |
| Sapphire | 7.70 | 345 | 20.0 | 0.27 | 375-708 | 1.77 |
| AlON | 6.76 | 321 | 7.0 | 0.26 | 622 | 1.79 |

Protective layers 134 and 136 represent layers of durable material that are formed to glass layer 132 to provide a tougher and more damage resistant surface to display surface structure 130 that would be provided by glass layer 132 alone. In addition, protective layers 134 and 136 are transparent at a broad range of optical and infrared light wavelengths, are good thermal conductors, and provide other optical, mechanical, or thermal characteristics suitable for use in touch panel display 100. An example of protective layers 134 and 136 include magnesium fluoride (MgF₂), sapphire, aluminum oxynitride (AlON), a MgAl₂O₄ transparent nano-ceramic, another material, a transparent barrier structure of silicon oxide (SiOx)/silicon nitride (SiNx)(SiOx)/silicon nitride (SiNx), or another multi-layered material, as needed or desired. Table 1, above, illustrates the mechanical properties associated with various materials that can be utilized in providing protective layers 134 and 136. The material used in protective layers 134 and 136 can be selected based upon the mechanical properties of the various materials. For example, where display surface structure 130 is expected to operate under a wide variety of external and internal temperatures, a material with a Coefficient of Thermal Expansion (CTE) that is closest to that of glass layer 132 (e.g., sapphire or AlON) may be more desirable for protective layers 134 and 136. On the other hand, where display surface structure 130 is expected to radiate heat generated by touch panel display device 110 or other devices within the mobile device that incorporates touch panel display 100, then a material with a higher thermal conductivity, such as sapphire, may be more desirable.

Protective layers 134 and 136 are formed to glass layer 132 such that the protective layers are permanently affixed to the glass layer. In a particular embodiment, protective layers 134 and 136 are formed to glass layer 132 via a Chemical Vapor Deposition (CDV) coating process, a sputtering process, or another coating process as needed or desired. Protective layer 136 is further processed to provide a moth-eye pattern in the material of the protective layer. The moth-eye pattern is a fine array of bumps that provide a gradation of the refractive index of the material of protective layer 136, and provides improved anti-reflection and anti-glare properties to display surface structure 130, increases the surface area of protective layer 136 and thereby increases amount of radiated heat loss from the surface, decreases the surface area in the plane of the protective layer and thereby decreases the surface friction of the surface and improves the anti-finger print properties of the surface. Moreover, by controlling the design of the moth-eye pattern on protective layer 136, display surface structure 130 can be designed to be selectively tuned to optimize the light emission at a selected wavelength. In a particular embodiment,

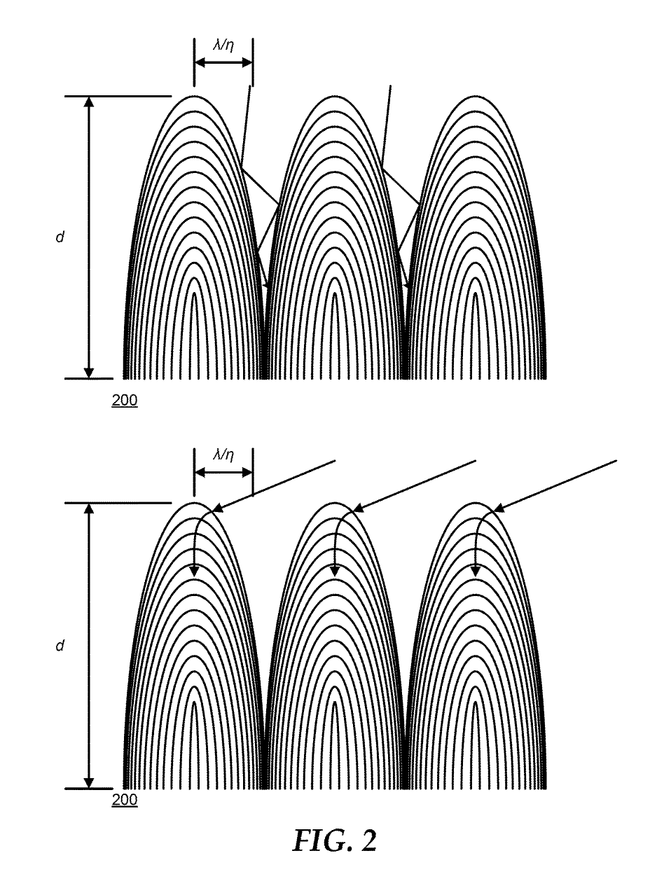

FIG. 2 illustrates a moth-eye surface 200. The top figure shows that light incident on moth-eye surface 200 at a steep angle is successively reflected off of the surface and downward into the surface. The bottom figure shows that light incident on moth-eye surface 200 at a shallow angel is refracted by the surface downward and into the surface. The optimum wavelength of light for moth-eye surface 200 is tunable based upon the design of the moth-eye surface. In particular, the optimum wavelength is given as:

d=λ/η Equation 1

where d is the height of the moth-eye pattern, λ is the optimum wavelength, and η is the refractive index of the material used in creating the moth-eye surface. Thus, where moth-eye surface 200 is desired to emit light in visible wavelengths (e.g., 400-1000 nm), and the selected material is sapphire, then moth-eye surface 200 should be designed with a height of 225-565 nm. For example, if moth-eye surface 200 is designed to be optimized for 700 nm, then:

d=700 nm/1.77=395 nm Equation 2

and so the height of the moth-eye surface should be greater than 395 nm to permit a moth-eye pattern that is 395 nm high. In another example, where moth-eye surface 200 is desired to emit light in near infrared wavelengths (e.g., 1000-2000 nm, such as for better heat emission), and the selected material is sapphire, then moth-eye surface 200 should be designed with a height of 565-1130 nm. For example, if moth-eye surface 200 is designed to be optimized for 2000 nm, then:

d=2000 nm/1.77=1130 nm Equation 2

and so the height of the moth-eye surface should be greater than 1130 nm to permit a moth-eye pattern that is 1130 nm high. In a particular embodiment, a moth-eye surface with a height of 1000 nm provides a desirable balance between a design for optimal optical performance and a design for optimal thermal performance.

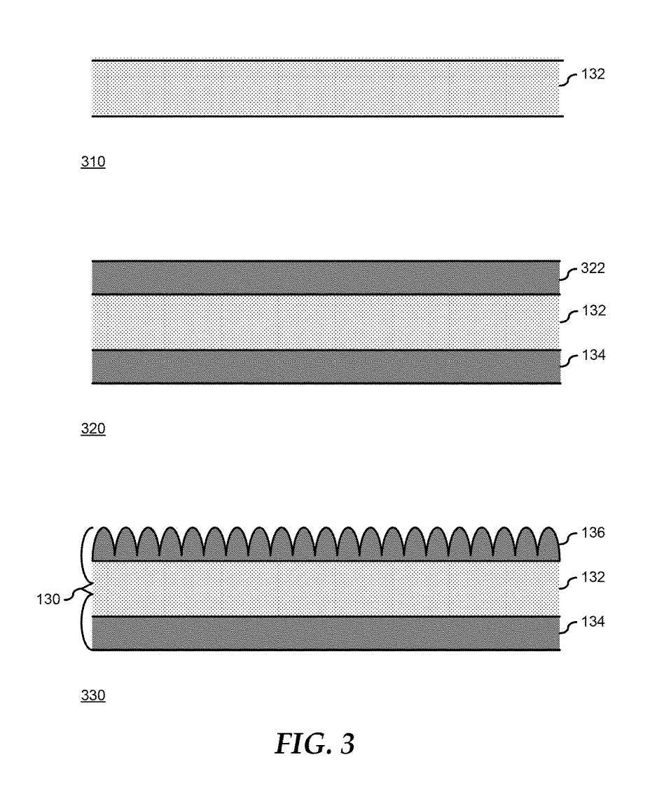

FIG. 3 illustrates a process for forming display surface structure 130. In a first step 310, glass layer 132 is provided as a starting element of display surface structure 130. In a next step 320, protective layers 134 and 322 are formed on glass layer 132. In a particular embodiment, protective layers 134 and 322 are formed on glass layer 132 via a CVD process to grow the protective layers on the surface of the glass layer. Here, the thickness of protective layers 134 and 322 can be controlled based upon the CVD process and the material used in forming the protective layers. In another embodiment, glass layer 132 is seeded with a thin layer of a crystalline material, such as sapphire, and then protective layers 134 and 322 are grown onto the crystalline material epitaxially. In yet another embodiment, protective layers 134 and 322 are bonded to glass layer 132 using an adhesive material. In a final step 330, protective layer 322 is etched to form the moth-eye pattern, thereby forming protective layer 136. In particular, a mask is applied to the surface of protective layer 322 that prevents the etching of the material of the protective layer in desired areas of the surface and that permits the etching of the material in other areas of the surface. Then an etching process is performed to etch away the excess material and leave intact the moth-eye pattern. In a particular embodiment, multiple cycles of masking and etching are performed to create the moth-eye pattern. In another embodiment, the mask layer operates to define self-aligned moth-eye pattern and only one etching step is utilized in creating the moth-eye pattern. By carefully controlling the etching process, the height and width of the moth-eye pattern can be controlled, thereby selecting the optical properties of the resulting protective layer, as described above. In a particular embodiment, the etching process is a wet etch, where the surface of protective layer 322 is exposed to various etching solutions as are known in the art. In another embodiment, the etching process is a plasma etch, where the surface of protective layer 322 is exposed to various plasma environments as are known in the art.

In another embodiment, a moth-eye pattern is formed on in a protective layer by depositing a monolayer of lithography material nanospheres on the protective layer. The nanoshperes are etched to a desired dimension by an etchant suited to etching the lithography material. Here, the etched nanospheres mask the protective layer and are located at the tops of each moth-eye bump. The protective layer is then etched to a desired height by an etchant suited to etching the material of the protective layer, and the nanospheres are cleaned off of the surface of the protective layer, leaving exposed the moth-eye pattern.

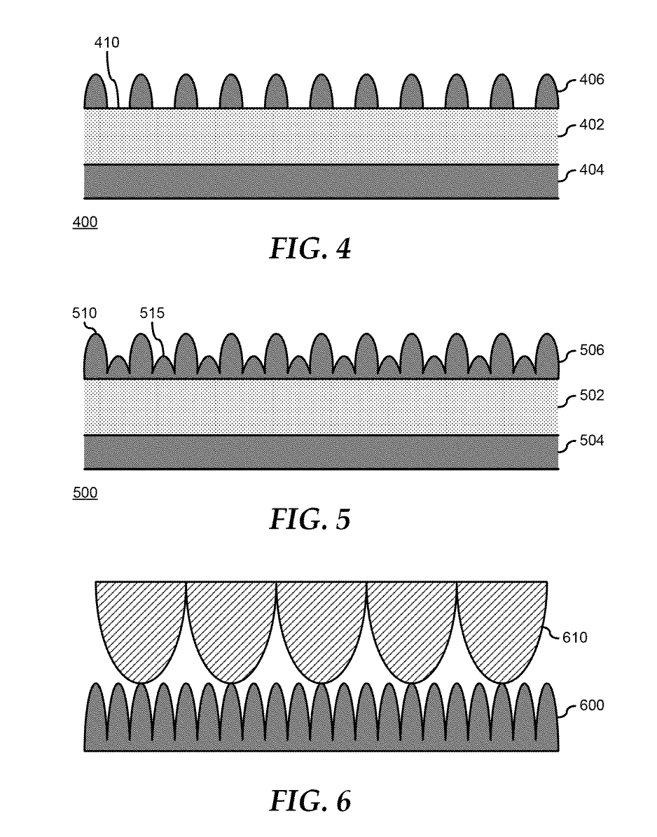

FIG. 4 illustrates a display surface structure 400, including a glass layer 402 and protective layers 404 and 406. Glass layer 402 is similar to glass layer 132, and protective layer 404 is similar to protective layer 134. However, protective layer 406 illustrates a moth-eye pattern where portions of the material of the protective layer have been etched for a long enough time to expose glass layer 402. In this way, protective layer 406 provides openings 410 to glass layer 402 that are not covered by protective layer 406. In this way, display surface structure 400 is provided that permits more light to be emitted through glass layer 402 without obstruction from protective layer 406. Here, display surface structure 400 is provided with a tougher surface with the enhanced anti-glare and anti-reflection properties, but can be seen to provide a brighter image than where all of glass layer 402 is covered by protective layer 406.

FIG. 5 illustrates a display surface structure 500, including a glass layer 502 and protective layers 504 and 506. Glass layer 502 is similar to glass layer 132, and protective layer 504 is similar to protective layer 134. However, protective layer 506 illustrates a moth-eye pattern where two different bump patterns have been etched into the material of the protective layer. A first bump 510 has a taller profile, and thus can be optimized to a longer wavelength of light, and a second bump 515 has a shorter profile, and thus can be optimized to a shorter wavelength of light. In this way, protective layer 510 provides a balance between optical and thermal performance, and by varying the bump profiles 510 and 515, a designer has a wide range of design latitude in fashioning the performance characteristics of display surface structure 500.

FIG. 6 illustrates a protective layer 600, similar to protective layer 136. However, here, protective layer 600 has a bump pattern that is significantly taller than the bump patterns on protective layer 136. Here, protective layer 600 is optimized to provide a lower friction between the protective layer and a contacting item 610. In particular, where contacting item 610 represents bumps in a typical finger print, or a pointed tip of a stylus, the contacting item can have a bump height of approximately 20 micro-meters (μm). Here, a bump height of the moth-eye pattern of protective layer 600 is on the order of one-half of the bump height of contacting item 610. In a particular embodiment, a bump height for protective layer 600 of 10 μm provides a significant reduction in the friction between the protective layer and contacting item 610. In addition, the taller bump pattern of protective layer 600 provides less planar surface area for the adhesion of oils, such as from a finger print, and thus the protective layer provides enhanced anti-finger print properties.

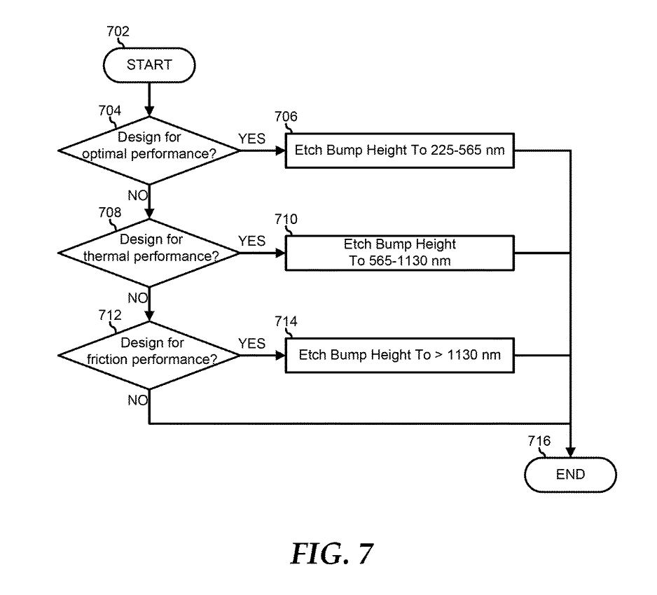

FIG. 7 shows a method of providing a sapphire protective layer for a display surface structure, starting at block 702. A decision is made as to whether the protective layer is to be designed for optimal optical performance in decision block 704. If so, the “YES” branch of decision block 704 is taken, the protective layer is etched to create a moth-eye bump that is between 255 and 565 nm in block 706, and the method ends in block 716. If the protective layer is not to be designed for optimal optical performance, the “NO” branch of decision block 704 is taken and a decision is made as to whether the protective layer is to be designed for optimal thermal performance in decision block 708. If so, the “YES” branch of decision block 708 is taken, the protective layer is etched to create a moth-eye bump that is between 565 and 1130 nm in block 710, and the method ends in block 716. If the protective layer is not to be designed for optimal thermal performance, the “NO” branch of decision block 708 is taken and a decision is made as to whether the protective layer is to be designed for optimal frictional performance in decision block 712. If so, the “YES” branch of decision block 712 is taken, the protective layer is etched to create a moth-eye bump that is greater than 1130 nm in block 714, and the method ends in block 716. If the protective layer is not to be designed for optimal frictional performance, optical performance, the “NO” branch of decision block 704 is taken and the method ends in block 716.

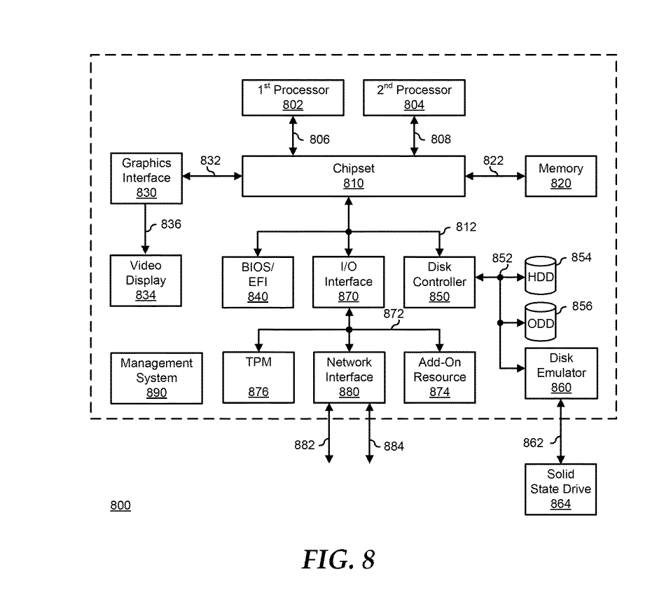

FIG. 8 illustrates a generalized embodiment of information handling system 800. For purpose of this disclosure information handling system 800 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 800 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 800 can include processing resources for executing machine-executable code, such as a central processing unit (CPU), a programmable logic array (PLA), an embedded device such as a System-on-a-Chip (SoC), or other control logic hardware. Information handling system 800 can also include one or more computer-readable medium for storing machine-executable code, such as software or data. Additional components of information handling system 800 can include one or more storage devices that can store machine-executable code, one or more communications ports for communicating with external devices, and various input and output (I/O) devices, such as a keyboard, a mouse, and a video display. Information handling system 800 can also include one or more buses operable to transmit information between the various hardware components.

Information handling system 800 can include devices or modules that embody one or more of the devices or modules described above, and operates to perform one or more of the methods described above. Information handling system 800 includes a processors 802 and 804, a chipset 810, a memory 820, a graphics interface 830, include a basic input and output system/extensible firmware interface (BIOS/EFI) module 840, a disk controller 850, a disk emulator 860, an input/output (I/O) interface 870, a network interface 880, and a management system 890. Processor 802 is connected to chipset 810 via processor interface 806, and processor 804 is connected to the chipset via processor interface 808. Memory 820 is connected to chipset 810 via a memory bus 822. Graphics interface 830 is connected to chipset 810 via a graphics interface 832, and provides a video display output 836 to a video display 834. In a particular embodiment, information handling system 800 includes separate memories that are dedicated to each of processors 802 and 804 via separate memory interfaces. An example of memory 820 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 840, disk controller 850, and I/O interface 870 are connected to chipset 810 via an I/O channel 812. An example of I/O channel 812 includes a Peripheral Component Interconnect (PCI) interface, a PCI-Extended (PCI-X) interface, a high speed PCI-Express (PCIe) interface, another industry standard or proprietary communication interface, or a combination thereof. Chipset 810 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 840 includes BIOS/EFI code operable to detect resources within information handling system 800, to provide drivers for the resources, initialize the resources, and access the resources. BIOS/EFI module 840 includes code that operates to detect resources within information handling system 800, to provide drivers for the resources, to initialize the resources, and to access the resources.

Disk controller 850 includes a disk interface 852 that connects the disc controller to a hard disk drive (HDD) 854, to an optical disk drive (ODD) 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits a solid-state drive 864 to be connected to information handling system 800 via an external interface 862. An example of external interface 862 includes a USB interface, an IEEE 1394 (Firewire) interface, a proprietary interface, or a combination thereof. Alternatively, solid-state drive 864 can be disposed within information handling system 800.

I/O interface 870 includes a peripheral interface 872 that connects the I/O interface to an add-on resource 874, to a TPM 876, and to network interface 880. Peripheral interface 872 can be the same type of interface as I/O channel 812, or can be a different type of interface. As such, I/O interface 870 extends the capacity of I/O channel 812 when peripheral interface 872 and the I/O channel are of the same type, and the I/O interface translates information from a format suitable to the I/O channel to a format suitable to the peripheral channel 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on separate circuit board or add-in card disposed within information handling system 800, a device that is external to the information handling system, or a combination thereof.

Network interface 880 represents a NIC disposed within information handling system 800, on a main circuit board of the information handling system, integrated onto another component such as chipset 810, in another suitable location, or a combination thereof. Network interface device 880 includes network channels 882 and 884 that provide interfaces to devices that are external to information handling system 800. In a particular embodiment, network channels 882 and 884 are of a different type than peripheral channel 872 and network interface 880 translates information from a format suitable to the peripheral channel to a format suitable to external devices. An example of network channels 882 and 884 includes InfiniBand channels, Fibre Channel channels, Gigabit Ethernet channels, proprietary channel architectures, or a combination thereof. Network channels 882 and 884 can be connected to external network resources (not illustrated). The network resource can include another information handling system, a data storage system, another network, a grid management system, another suitable resource, or a combination thereof.

Management system 890 provides for out-of-band monitoring, management, and control of the respective elements of information handling system 800, such as cooling fan speed control, power supply management, hot-swap and hot-plug management, firmware management and update management for system BIOS or UEFI, Option ROM, device firmware, and the like, or other system management and control functions as needed or desired. As such, management system 890 provides some or all of the functions and features of the management systems, management controllers, embedded controllers, or other embedded devices or systems, as described herein.

For the purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

The preceding discussion focused on specific implementations and embodiments of the teachings. This focus has been provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A surface structure for a touch panel display, the surface structure comprising:
a glass layer having a first surface and a second surface, the first surface being on an interior side of the glass layer and the second surface being on an exterior side of the glass layer;
a first protective layer formed to the first surface; and
a second protective layer formed to the second surface, the second protective layer including an array of bumps on an exterior side of the glass layer, the array of bumps providing a gradation of a refractive index of a material of the second protective layer.

2. The surface structure of claim 1, wherein the array of bumps is configured to provide the gradation of the refractive index of the material of the second protective layer for light having a wavelength between 400 nanometers and 1000 nanometers.

3. The surface structure of claim 1, wherein the array of bumps is configured to provide the gradation of the refractive index of the material of the second protective layer for light having a wavelength between 1000 nanometers and 2000 nanometers.

4. The surface structure of claim 1, wherein the array of bumps is configured with a bump height of less than 10 micrometers.

5. The surface structure of claim 1, wherein the material of the second protective layer comprises a sapphire material.

6. The surface structure of claim 1, wherein the material of the second protective layer comprises a magnesium fluoride material.

7. The surface structure of claim 1, wherein the material of the second protective layer comprises an aluminum oxynitride material.

8. The surface structure of claim 1, wherein the array of bumps are formed by etching the material of the second protective layer.

9. The surface structure of claim 8, wherein the material of the second protective layer is etched to expose the glass layer between the bumps of the array of bumps.

10. The surface structure of claim 1, wherein the array of bumps is configured to bumps having at least two different bump heights.

11. A touch panel display comprising:
a touch panel device; and
surface structure adhered to the touch panel device, the surface structure including:
a glass layer having a first surface and a second surface, the first surface being on an interior side of the glass layer and the second surface being on an exterior side of the glass layer;
a first protective layer formed to the first surface; and
a second protective layer formed to the second surface, the second protective layer comprising an array of bumps on an exterior side of the glass layer, the array of bumps providing a gradation of a refractive index of a material of the second protective layer.

12. The touch panel display of claim 11, wherein the array of bumps is configured to provide the gradation of the refractive index of the material of the second protective layer for light having a wavelength between 400 nanometers and 1000 nanometers.

13. The touch panel display of claim 11, wherein the array of bumps is configured to provide the gradation of the refractive index of the material of the second protective layer for light having a wavelength between 1000 nanometers and 2000 nanometers.

14. The touch panel display of claim 11, wherein the array of bumps is configured with a bump height of less than 10 micrometers.

15. The touch panel display of claim 11, wherein the material of the second protective layer comprises a sapphire material.

16. The touch panel display of claim 15, wherein the material of the second protective layer comprises a magnesium fluoride material.

17. The touch panel display of claim 11, wherein the material of the second protective layer comprises an aluminum oxynitride material.

18. The touch panel display of claim 11, wherein the array of bumps are formed by etching the material of the second protective layer, and the material of the second protective layer is etched to expose the glass layer between the bumps of the array of bumps.

19. The touch panel display of claim 11, wherein the array of bumps is configured to bumps having at least two different bump heights.

20. A method of forming a surface structure for a touch panel display, the method comprising:
providing a glass layer having a first surface and a second surface, the first surface being on an interior side of the glass layer and the second surface being on an exterior side of the glass layer;
forming a first protective layer to the first surface;
forming a second protective layer to the second surface; and
etching the second protective layer to provide an array of bumps on an exterior side of the glass layer, the array of bumps providing a gradation of a refractive index of a material of the second protective layer.
